(19) United States
(12) Patent Application Publication
(10) Pub. No.: US 2019/0030392 A1
(43) Pub. Date: Jan. 31, 2019

(54) WEIGHTED MAT

(71) Applicant: Lori Anne Skerjanz, Whitestone, SC (US)

(72) Inventor: Lori Anne Skerjanz, Whitestone, SC (US)

(21) Appl. No.: 15/659,158

(22) Filed: Jul. 25, 2017

(51) Int. Cl. A63B 21/00; B32B 7/04; B32B 27/08; A63B 21/06; A63B 23/00

(52) U.S. Cl. CPC A63B 21/4037; B32B 7/045; B32B 27/08; A63B 2023/006; A63B 23/00; B32B 2471/04; A63B 21/0602

(57) ABSTRACT

A weighted mat includes a top layer of material, a bottom layer of material, and a series of tubes or compartments between the top and bottom layers for holding a weighted material. The top and bottom layers of material preferably include a series of generally evenly spaced seams that connect the top and bottom layers, which leaves a tubular space between the seams. Weighted material is placed within the tubes created by the seams, and the weighted material is preferably in a particulate form that allows the weighted material to flow from one end of the tube to the other. In use, the weighted mat may simply be used as a mat or cushion on a hard surface, or it may be applied to or draped over a particular body part during a yoga pose or stretching exercise to intensify the effects of gravity.

### TECHNICAL FIELD

The invention relates generally to devices used it connection with yoga, strength training and massage therapy to increase overall health and well being, increase athletic performance, injury and surgery rehabilitation, and the like. More specifically, the present invention includes a mat having interior channels or compartments that hold a weighted material, wherein the weighted material may shift within the compartments in order to provide more weight in some areas of the mat and less weight in other areas.

### BACKGROUND OF THE INVENTION

Yoga is the Hindu practice of physical, mental and spiritual discipline originating in ancient India, and is widely used throughout the world to improve. physical and mental health. There are a variety of yoga disciplines, but generally speaking, the practice of yoga includes different types of stretching exercises, poses and postures, which are used to promote and aid flexibility, balance, and whole body strength.

In recent years, different types of yoga props or aids have been developed to assist users in achieving optimal stretches, improve muscle strength and conditioning, and increase circulation and healing. Many of the stretching regimens include poses and postures where constricted muscles require aid in lengthening. Some of these stretching aids include weights and weighted devices that may be placed on a user's body during poses, which adds weight to assist in stretching a user's muscles or muscle groups, and which further stabilize the body in stretches and yoga positions. Other devices include straps, ropes, pillows, blocks and sandbags.

Previous efforts to provide weighted devices (for various purposes) and similar weighted stretching aids are as follows, and each of the references included below are hereby incorporated herein by reference, in their entireties:

U.S. Pat. No. 4,654,906—Beach Blanket with Sand Pockets

A beach blanket rectangular shape and four corners has a right triangular pocket at each corner to receive and temporarily hold a quantity of sand for anchoring the blanket, the pockets being closable to secure the sand therein and openable far discharge of the sand.

U.S. Pat. No. 5,720,058—Comforter

A comforter includes a main body portion and a peripheral region extending along at least one edge of the main body portion. With the comforter placed on a bed, the peripheral region defines an at least partially enclosed space between the upper surface of the bed and the main body portion of the comforter. The main body portion contains a fill material in a first weight per unit area and the peripheral region contains a fill material in a second weight per unit area greater than the first weight per unit area. In use, the greater weight per unit area of the peripheral region substantially reduces air circulation into and out from the at least partially enclosed space, creating insulating qualities that are improved over conventional comforters.

U.S. Pat. No. 7,870,623—Weighted Article

A weighted article for providing deep pressure therapy includes a plurality of patchwork pieces including a plurality of layers. At least some of the patchwork pieces include a filler of weighted material contained between at least two of the plurality of layers. The plurality of patchwork pieces are fastened together at edges.

U.S. Pat. No. 4,709,430—Weighted Beach Blanket

A multi-purpose weighted blanket for covering areas of beaches or like terrain comprising first and second flexible cloth panels substantially rectangular in shape and identical in size. The first and second cloth panels having a border extending continuously along the outer perimeter edges thereof forming a reinforced retaining pocket for securing an anchoring device thereto. The anchoring device includes a non-metallic tube filled with a liquid with a liquid weight such as water. The non-metallic tube has a memory of restoring the tube to its original configuration upon the removal of an external force acting thereon. The anchoring devices operates to aid an individual in positioning the blanket as well as maintaining the blanket in its fully extended position. Additionally, the anchoring device prevents foreign particles such as sand or the like from soiling the reclining surface of the blanket.

U.S. Application No. U.S. 2004/0031099 A1—Weighted Blanket

A blanket or cover with a weighted perimeter or border for covering mammals or humans is provided. The blankets or covers of variable thickness and/or weight and made of various known materials or fabrics having a weighted perimeter or border provide an “anchoring” ability to keep the blanket or cover in the position desired and chosen by the user.

U.S. Application No. U.S. 2014/0213421 A1—Weighted Device

A weighted device, flexible in nature, containing a material with density of at least 200 kg/m³, such that the total weight of the device is evenly distributed over the area of said device is presented. This distribution of weight being maintained regardless of the position of the device by sections or compartment within the device which contain a weighted material such that the overall weight of the device is 5-40 lbs, optimally 15-20 lbs. This device is used in yoga, stretching, strength training and massage therapy to increase overall health and well being, increase athletic performance, rehabilitate after excess exercise, injury, surgery, or alleviate chronic illness symptoms. Methods of using the device are also presented.

U.S. Application No. U.S. 2009/0100568 A1—Weighted Article

A we article for providing deep pressure therapy includes a plurality of patchwork pieces including a plurality of layers. At least some of the patchwork pieces include a filler of weighted material contained between at least two of the plurality of layers. The plurality of patchwork pieces are fastened together at edges.

None of these devices, however, provide a weighted mat that includes weighted portions throughout the entirety of the apparatus, wherein the weighted material may shift within the compartments to desired portions therein. These and other advantages and benefits of the present invention are described herein.

### SUMMARY OF THE INVENTION

The above objectives are accomplished according to the present invention by providing, in a first embodiment, a weighted mat including a top layer of material, a bottom layer of material, and a series of tubes or compartments between the top and bottom layers that include a weighted material, such as sand, gel, seeds, gravel, stone, beads, metal or plastic. In a preferred embodiment, the weighted material may shift within a compartment from one end to the other, as dictated by gravity or other forces, so that certain portions of each compartment may be heavier than other portions of the compartment.

In a preferred embodiment, the compartments are essentially tubular shaped, and run the full length or width of the mat, so that the weighted material may shift from one end to the other, or may be distributed more evenly on a flat surface. The weighted material should include particulate that is small enough to flow through the tubes freely. The amount of the weighted material that is used in each tube may be varied to include more or less weight, and the density of the weighted material may be varied as but it is preferred that the weighted material be allowed some freedom of movement from one end of each tube to the other.

Other embodiments are envisioned, wherein the tubes may run in a diagonal direction with respect to the mat, or in any desired manner, so long as the weighted material may freely flow within the compartments to distribute the weight as desired.

### DESCRIPTION OF THE DRAWINGS

The invention will be more readily understood from a reading of the following specification and by reference to the accompanying drawings forming a part thereof, wherein an example of the invention is shown and wherein:

FIG. 1 shows a top view of one embodiment of the weighted mat, including a series of parallel sleeves that contain a weighted material, so that the weighted material may shift longitudinally along the inner portions of the sleeves;

FIG. 2 is a side view of one embodiment of the weighted mat along longitudinal side thereof;

FIG. 3 is a side view of one embodiment of the weighted mat along a lateral side thereof;

FIG. 4 is a cross sectional view of one embodiment of the weighted mat along the lines 4-4 shown in FIG. 1;

FIG. 5 is a side perspective view of a person using one embodiment of the weighted mat on one leg for floor exercises;

FIG. 6 is a side perspective view of a person using one embodiment of the weighted mat on both legs for floor exercises; and

FIG. 7 is a perspective view of a person using one embodiment of the weighted mat for floor exercises.

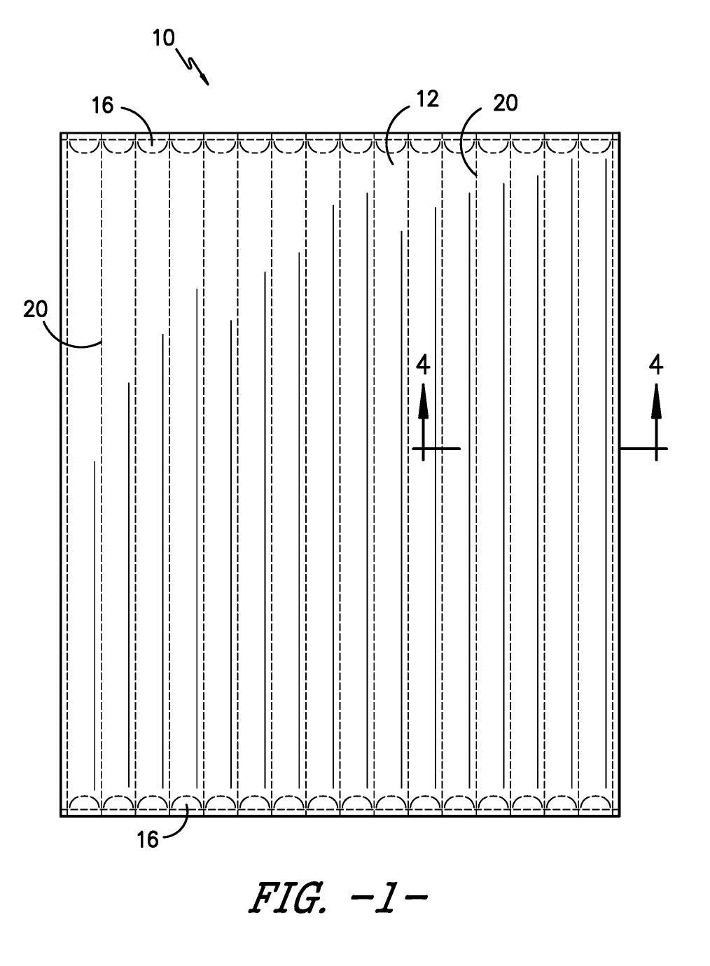

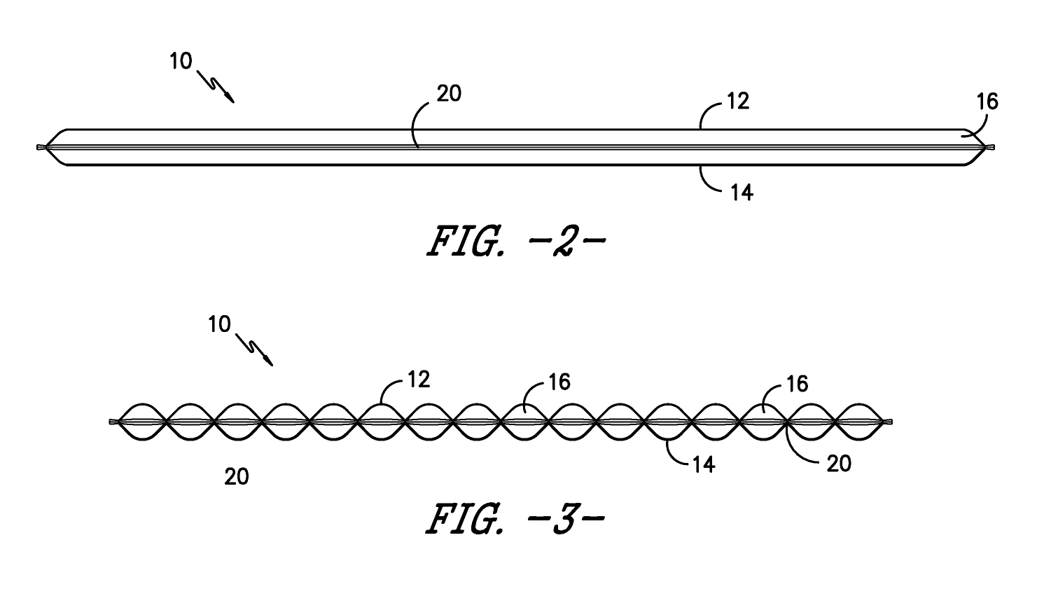

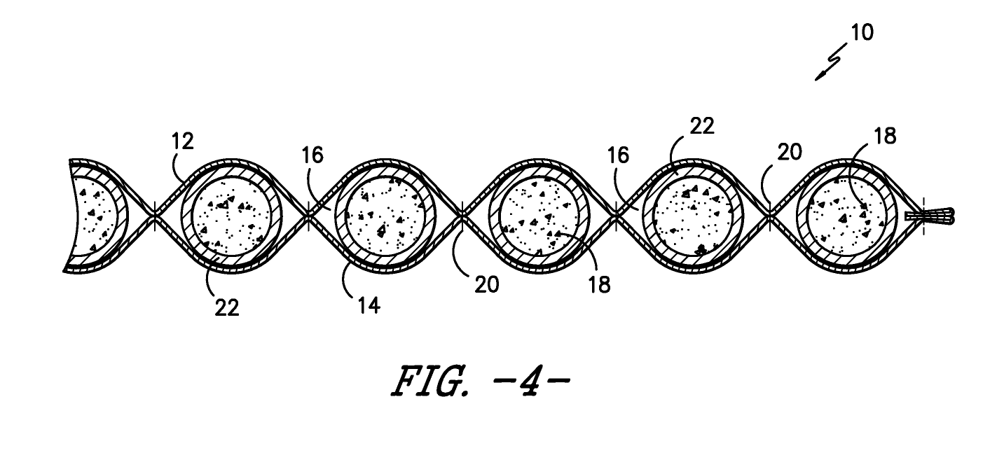

### DESCRIPTION OF A PREFERRED EMBODIMENT

Referring now to the drawings, the invention will be described in more detail. In a preferred embodiment, a weighted mat 10 includes a top layer of material 12, a bottom layer of material 14, and a series of tubes or compartments 16 between the top and bottom layers for holding a weighted material 18. The top and bottom layers of material 12, 14 preferably include a series of generally evenly spaced seams 20 that connect the top and bottom layers 12, 14, which leaves a tubular space between the seams 20. Weighted material 18 is placed within the tubes 16 created by the seams 20, and the weighted material 18 is preferably in a granular or other form that allows the weighted material 18 to flow from one end of the tube 16 to the other. It is contemplated that the compartments 16 formed between the seams 20 may serve as tubes to hold the weighted material, or alternatively, a separate tube 22 may be inserted into the compartments 16 between the seams 20 to hold the weighted material 18, as shown in FIG. 4.

The material that forms the top and bottom layers 12, 14 may be made of the same material, such as nylon, polyester, cotton, silk, polypropylene, or any other suitable material. It is also contemplated that the top layer 12 may be made from a first material, and the bottom layer 14 may be made from a second material, as desired. The mat 10 itself may be formed into any desired shape, including a square, rectangle, circle, triangle, or any other desired shape.

The tubes 16 preferably run longitudinally or transversely along the mat 10, although it is contemplated that the tubes 16 may run diagonally (corner to corner, for instance), so long as the weighted material 18 is allowed to freely flow within the tubes 16 to distribute the weight within the tubes 16 as desired. The weighted material 18 may be formed from any suitable material, such as sand, gel, seeds, gravel, stone, beads, metal or plastic, and should be formed into particulate that is small enough to flow freely through the tubes or compartments 16.

It is contemplated that the tubes 16 may include openings that may allow weighted material 18 to be added or removed, and the openings may include a zipper or other closure device to seal the weighted material 18 within the tubes during use of the weighted mat 10. In this way, more weighted material 18 can be added to any or all tubes 16, or may be removed from any or all tubes 16. Or, if a user desires to use a different weighted material 18 (a lighter weighted material, for instance) a first weighted material 18 may be removed from the tubes 16 and a second weighted material 18 may be added to the tubes 16 and sealed therein for use.

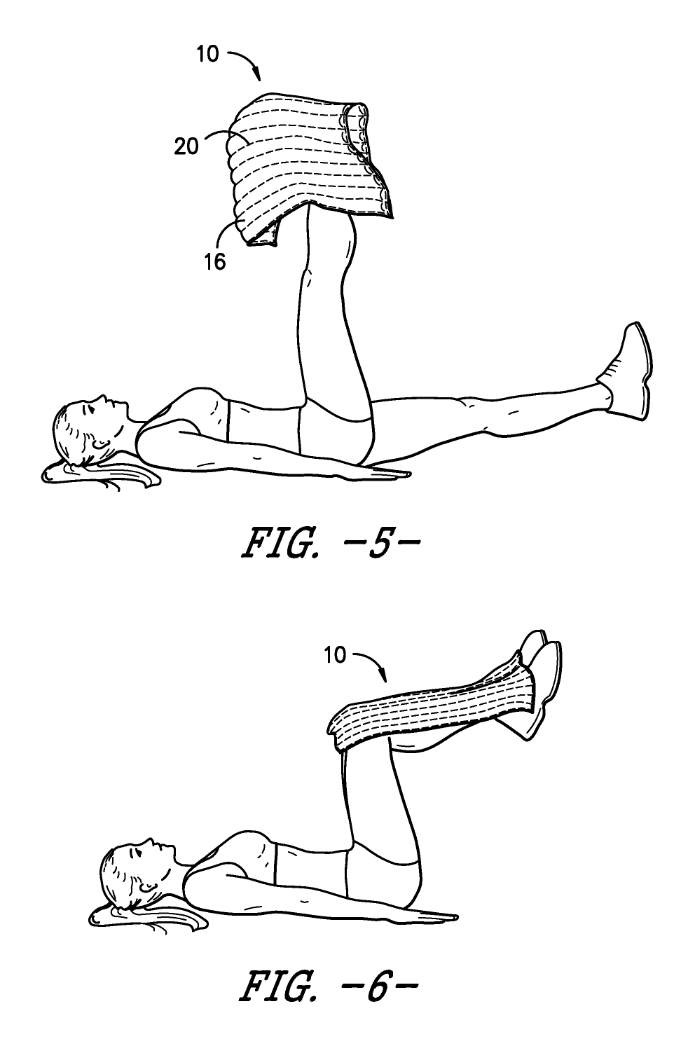

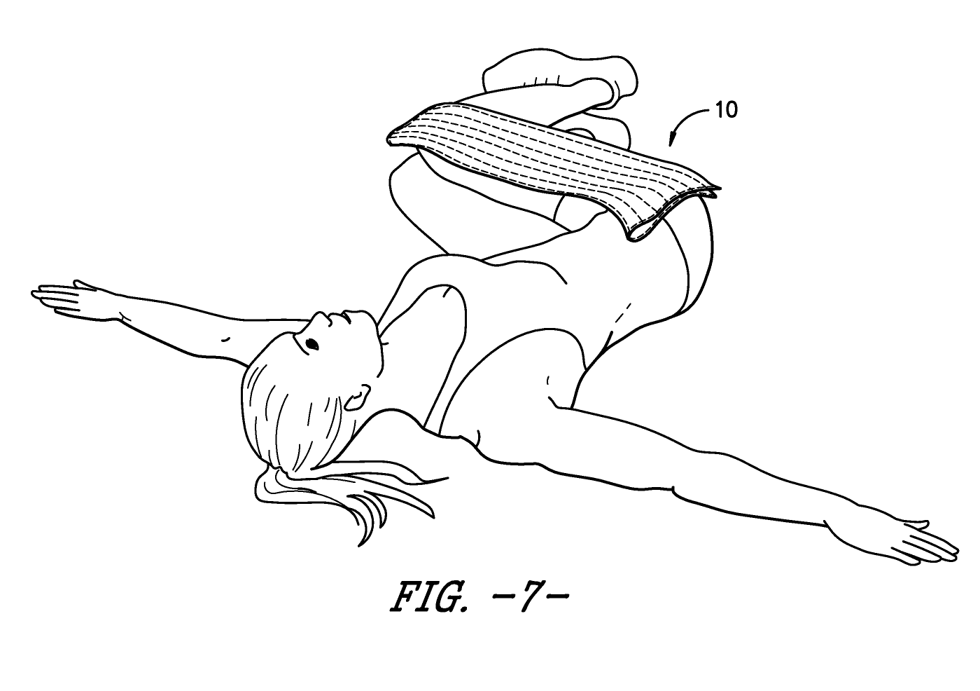

In use, the weighted mat 10 may simply be used as a mat or cushion on a hard surface, or it may be applied to or draped over a particular body part during a yoga pose or stretching exercise to intensify the effects of gravity, as shown in FIGS. 5-7. The weighted mat 10 may be draped over a user's arms, legs, or any other desired body part during a yoga pose or exercise, and because the weighted material 18 is allowed to flow freely through the tubes 16, the weighted mat 10 has a tendency to stay draped where it is placed on the body during such exercises or yoga poses. A single weighted mat 10 may be used, or multiple mats may be draped over different portions of a user's body simultaneously to provide additional gravitational effects, as desired.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A weighted mat comprising:
a top layer of material;
a bottom layer of material attached to said top layer of material;
a series of tubular compartments positioned in parallel relation between said top and bottom layers of material; and
a weighted material disposed within each of said tubular compartments, so that said weighted material may freely flow throughout and within each said tubular compartment, and wherein said weighted material may be unevenly distributed throughout said mat.

2. The weighted mat at set forth in claim 1, wherein said top layer of material is selected from the group consisting of nylon, polyester, cotton, silk, polypropylene, and any combination thereof.

3. The weighted mat set forth in claim 1, wherein said bottom layer of material is selected from the group consisting of nylon, polyester, cotton, silk, polypropylene, and any combination thereof.

4. The weighted mat set forth in claim 1, wherein said weighted material is selected from the group consisting of sand, gel, seeds, gravel, stone, beads, metal, plastic, and any combination thereof.

5. The weighted mat set forth in claim 1, wherein each said tubular compartment includes a sealable opening, so that said weighted material may be added to or removed front each said tubular compartment.
